(19) United States
(12) Patent Application Publication
(10) Pub. No.: US 2026/0122624 A1
(43) Pub. Date: Apr. 30, 2026

(54) SIGNAL TRANSMISSION/RECEPTION METHOD FOR WIRELESS COMMUNICATION, AND DEVICE THEREFOR

(71) Applicant: LG ELECTRONICS INC., Seoul (KR)

(72) Inventors: Youngdae LEE, Seoul (KR); Jaehyung KIM, Seoul (KR); Seungjin AHN, Seoul (KR); Suckchel YANG, Seoul (KR); Seonwook KIM, Seoul (KR); Sunghoon LEE, Seoul (KR)

(73) Assignee: LG ELECTRONICS INC., Seoul (KR)

(21) Appl. No.: 19/116,945

(22) PCT Filed: Sep. 27, 2023
(86) PCT No.: PCT/KR2023/015079

§ 371 Date: Mar. 28, 2025

Related U.S. Application Data
(60) Provisional application No. 63/411,184, filed on Sep. 29, 2022.
(60) Provisional application No. 63/411,192, filed on Sep. 29, 2022.

(51) Int. Cl. H04W 72/0453; H04W 72/232

(52) U.S. Cl. CPC H04W 72/0453; H04W 72/232

(57) ABSTRACT

A terminal according to one embodiment receives a DCI through a PDCCH, and transmits or receives a signal on the basis of a frequency domain resource allocation field included in the DCI, wherein, on the basis that the FDRA field allocates a plurality of frequency resources for a bandwidth exceeding a specific band size, the signal can be transmitted or received on the basis of the remaining frequency resources excluding at least one frequency resource from among the plurality of frequency resources.

### CROSS-REFERENCE TO RELATED APPLICATIONS

This application is the National Stage filing under 35 U.S.C. 371 of International Application No. PCT/KR2023/015079, filed on Sep. 27, 2023, which claims the benefit of U.S. Provisional Application Nos. 63/411,184 filed on Sep. 29, 2022, and 63/411,192 filed on Sep. 29, 2022, the contents of which are all hereby incorporated by reference herein in their entireties.

### TECHNICAL FIELD

The present disclosure relates to wireless communication, and more particularly, to a method of transmitting or receiving an uplink/downlink signal in a wireless communication system and apparatus therefor.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### SUMMARY

The object of the present disclosure is to provide a method of transmitting and receiving signals more accurately and efficiently.

The objects of present disclosure are not limited to what has been particularly described hereinabove, and other objects that the present disclosure could achieve will be more clearly understood from the following detailed description.

According to an aspect, a method of transmitting and receiving a signal by a user equipment (UE) in a wireless communication may include receiving downlink control information (DCI) through a physical downlink control channel (PDCCH), and transmitting or receiving a signal based on a frequency domain resource allocation (FDRA) field included in the DCI, and based on the FDRA field allocating a plurality of frequency resources for a bandwidth exceeding a specific bandwidth size, the signal may be transmitted or received based on the remaining frequency resources excluding at least one frequency resource from among the plurality of frequency resources.

The at least one frequency resource is a frequency resource of which index is outside a bandwidth of the specific band size from a frequency resource having a lowest or highest index from among the plurality of frequency resources.

The remaining frequency resources are frequency resources of which indices are included within a frequency band of the specific band size from a frequency resource having a lowest or highest index from among the plurality of frequency resources.

The at least one frequency resource is disregarded in receiving or transmitting the signal even if the at least one frequency resource is allocated by the FDRA field.

The UE reallocates frequency resources equal to a number of the at least one frequency resource excluded from among frequency resources not allocated by the FDRA field within a bandwidth of the specific band size as frequency resources for transmission of the signal.

The signal is transmitted or received on the remaining frequency resources and the reallocated frequency resources.

The signal is a physical downlink shared channel (PDSCH), a physical uplink shared channel (PUSCH), or a physical uplink control channel (PUCCH) scheduled by the DCI.

The DCI is received within a bandwidth part (BWP) supported for reception of the PDCCH, and the BWP is configured with a plurality of sub-BWPs having a bandwidth size less than or equal to the specific bandwidth size are configured, and the bandwidth of the specific bandwidth size is one sub-BWP indicated from among the plurality of sub-BWPs.

The specific bandwidth size is 5 MHz.

According to another aspect, a UE performing the signal transmission and reception method described above may be provided.

According to another aspect, a processing device for controlling a UE performing the signal transmission and reception method described above may be provided.

According to another aspect, a method of receiving a signal by a base station (BS) in a wireless communication may include transmitting downlink control information (DCI) through a physical downlink control channel (PDCCH), and receiving an uplink (UL) signal based on a frequency domain resource allocation (FDRA) field included in the DCI, and based on the FDRA field allocating a plurality of frequency resources for a bandwidth exceeding a specific bandwidth size, the UL signal is received based on the remaining frequency resources excluding at least one frequency resource from among the plurality of frequency resources.

According to another aspect, a BS performing the signal reception method described above may be provided.

According to an embodiment of the present disclosure, signal transmission and reception can be performed more accurately and efficiently in a wireless communication system.

The present disclosure is not limited to the technical effects described above, and other technical effects can be inferred from the detailed description.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIGS. 4 and 5 are drawings for explaining the structure and transmission method of an SSB (Synchronization Signal Block).

FIG. 6 illustrates a random access procedure.

FIG. 7 illustrates an example of physical channel mapping.

FIG. 8 is a diagram showing a flow of a method of transmitting and receiving a signal according to an embodiment.

FIG. 9 is a diagram for explaining a method of configuring a plurality of sub-BWPs in one BWP.

FIG. 10 is a diagram for explaining a method of transmitting and receiving a signal based on received DCI by a UE.

FIG. 11 is a diagram for explaining a method of receiving a UL signal by a BS from a UE.

FIGS. 12 and 13 illustrate a communication system 1 and wireless devices applied to the present disclosure.

FIG. 14 is a diagram for explaining a DRX (Discontinuous Reception) operation of a UE according to one embodiment.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto. LTE refers to technologies after 3GPP TS 36.xxx Release 8. Specifically, LTE technologies after 3GPP TS 36.xxx Release 10 are referred to as LTE-A, and LTE technologies after 3GPP TS 36.xxx Release 13 are referred to as LTE-A pro. 3GPP NR refers to technologies after TS 38.xxx Release 15. LTE/NR may be referred to as 3GPP systems. In this document, “xxx” represents the detail number of a specification. LTE/NR may be collectively referred to as 3GPP systems.

Details of the background, terminology, abbreviations, etc. used herein may be found in documents published before the present disclosure. For example, the present disclosure may be supported by the following documents:

### 3GPP NR

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

### Technical Terms Used in this Document

UE: User Equipment
SSB: Synchronization Signal Block
MIB: Master Information Block
RMSI: Remaining Minimum System Information
FR1: Frequency Range 1, which refers to the frequency range below 6 GHz (e.g., 450 MHz to 6000 MHz).
FR2: Frequency Range 2, which refers to the millimeter wave (mmWave) region above 24 GHz (e.g., 24250 MHz to 52600 MHz).
BW: Bandwidth
BWP: Bandwidth Part
RNTI Radio Network Temporary Identifier
CRC: Cyclic Redundancy Check
SIB: System Information Block
SIB1: SIB1 for NR devices=RMSI (Remaining Minimum System Information). Broadcasts information necessary for cell connection of NR UEs.
CORESET (COntrol REsource SET): Time/frequency resource for NR UE to attempt candidate PDCCH decoding
CORESET #0: CORESET for Type0-PDCCH CSS set for NR devices (Set in MIB)
Type0-PDCCH CSS set: a search space set in which an NR UE monitors a set of PDCCH candidates for a DCI format with CRC scrambled by a SI-RNTI
MO: PDCCH Monitoring Occasion for Type0-PDCCH CSS set
SIB1-R: (additional) SIB1 for reduced capability NR devices. May be limited to cases where it is generated as a separate TB from SIB1 and transmitted as a separate PDSCH.
CORESET #0-R: CORESET #0 for reduced capability NR devices
Type0-PDCCH-R CSS set: a search space set in which an redcap UE monitors a set of PDCCH candidates for a DCI format with CRC scrambled by a SI-RNTI
MO-R: PDCCH Monitoring Occasion for Type0-PDCCH CSS set
Cell defining SSB (CD-SSB): SSB containing RMSI scheduling information among NR SSBs
Non-cell defining SSB (non-CD-SSB): An SSB that is placed in the NR sync raster but does not contain RMSI scheduling information for the cell for measurement purposes. However, it may contain information indicating the location of the cell defining SSB.
SCS: subcarrier spacing
SI-RNTI: System Information Radio-Network Temporary Identifier
Camp on: “Camp on” is the UE state in which the UE stays on a cell and is ready to initiate a potential dedicated service or to receive an ongoing broadcast service.
TB: Transport Block
RSA (Redcap standalone): Cells that support only Redcap devices or services.
SIB1(-R)-PDSCH: PDSCH transmitting SIB1(-R)
SIB1(-R)-DCI: DCI for scheduling SIB1(-R)-PDSCH. DCI format 1_0 with CRC scrambled by SI-RNTI.
SIB1(-R)-PDCCH: PDCCH transmitting SIB1(-R)-DCI
FDRA: Frequency Domain Resource Allocation
TDRA: Time Domain Resource Allocation
RA: Random Access
MSGA: preamble and payload transmissions of the random access procedure for 2-step RA type.
MSGB: response to MSGA in the 2-step random access procedure. MSGB may consist of response(s) for contention resolution, fallback indication(s), and backoff indication.
RO-N: RACH Occasion (RO) for normal UE 4-step RACH and 2-step RACH (if configured)
RO-N1, RO-N2: When a separate RO is set for normal UE 2-step RACH, it is distinguished as RO-N1 (4-step) and RO-N2 (2-step).
RO-R: RO (RACH Occasion) set separately from RO-N for redcap UE 4-step RACH and 2-step RACH (if configured)
RO-R1, RO-R2: When a separate RO is set for redcap UE 2-step RACH, it is distinguished as RO-R1 (4-step) and RO-R2 (2-step).
PG-R: MsgA-Preambles Group for redcap UEs
RAR: Randoma Access Response
RAR window: the time window to monitor RA response(s)
FH: Frequency Hopping
iBWP: initial BWP
iBWP-DL(-UL): initial DL(UL) BWP
iBWP-DL(-UL)-R: (separate) initial DL(UL) BWP for RedCap
CS: Cyclic shift
NB: Narrowband

In the present disclosure, the term “set/setting” may be replaced with “configure/configuration”, and both may be used interchangeably. Further, a conditional expression (e.g., “if”, “in a case”, or “when”) may be replaced by “based on that” or “in a state/status”. In addition, an operation or software/hardware (SW/HW) configuration of a user equipment (UE)/base station (BS) may be derived/understood based on satisfaction of a corresponding condition. When a process on a receiving (or transmitting) side may be derived/understood from a process on the transmitting (or receiving) side in signal transmission/reception between wireless communication devices (e.g., a BS and a UE), its description may be omitted. Signal determination/generation/encoding/transmission of the transmitting side, for example, may be understood as signal monitoring reception/decoding/determination of the receiving side. Further, when it is said that a UE performs (or does not perform) a specific operation, this may also be interpreted as that a BS expects/assumes (or does not expect/assume) that the UE performs the specific operation. When it is said that a BS performs (or does not perform) a specific operation, this may also be interpreted as that a UE expects/assumes (or does not expect/assume) that the BS performs the specific operation. In the following description, sections, embodiments, examples, options, methods, schemes, proposals and so on are distinguished from each other and indexed, for convenience of description, which does not mean that each of them necessarily constitutes an independent disclosure or that each of them should be implemented only individually. Unless explicitly contradicting each other, it may be derived/understood that at least some of the sections, embodiments, examples, options, methods, schemes, proposals and so on may be implemented in combination or may be omitted.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

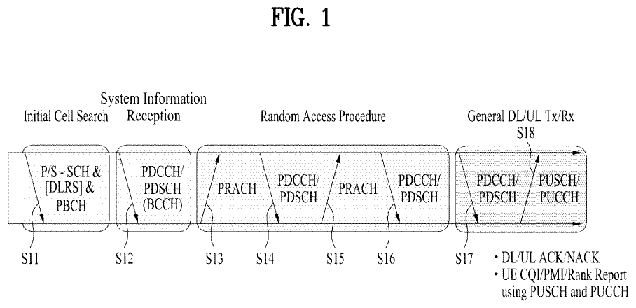

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S11. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

The SSB is composed of four consecutive OFDM symbols, each carrying the PSS, the PBCH, the SSS/PBCH, or the PBCH. Each of the PSS and the SSS includes one OFDM symbol by 127 subcarriers, and the PBCH includes three OFDM symbols by 576 subcarriers. The PBCH is encoded/decoded based on Polar codes, and modulation/demodulation is performed thereon according to quadrature phase shift keying (QPSK). The PBCH in the OFDM symbol consists of data resource elements (REs) to which a complex modulation value of the PBCH is mapped, and demodulation reference signal (DMRS) REs to which a DMRS for the PBCH is mapped. Three DMRS REs are configured for each RB in the OFDM symbol, and three data REs configured between DMRS REs.

The PSS may be used in detecting a cell ID within a cell ID group, and the SSS may be used in detecting a cell ID group. The PBCH may be used in detecting an SSB (time) index and a half-frame. There are 336 cell ID groups, and each cell ID group includes three cell IDs. Thus, there are a total of 1008 cell IDs.

SSBs are periodically transmitted with an SSB periodicity. A default SSB periodicity assumed by the UE in initial cell search is defined as 20 ms. After cell access, the SSB periodicity may be set to one of {5 ms, 10 ms, 20 ms, 40 ms, 80 ms, and 160 ms} by the network (e.g., BS). An SSB burst set may be configured at the beginning of the SSB periodicity. The SSB burst set may be set to a time window of 5 ms (i.e., half-frame), and the SSB may be repeatedly transmitted up to L times within the SS burst set. The maximum number of SSB transmissions L may be given depending carrier frequency bands as follows. One slot includes up to two SSBs.
For frequency range up to 3 GHz, L=4
For frequency range from 3 GHz to 6 GHz, L=8
For frequency range from 6 GHz to 52.6 GHz, L=64

The time-domain positions of candidate SSBs in the SS burst set may be defined depending on subcarrier spacings. The time-domain positions of the candidate SSBs are indexed from (SSB indices) 0 to L-1 in temporal order within the SSB burst set (i.e., half-frame).

Multiple SSBs may be transmitted within the frequency span of a carrier. Each SSB may not need to have a unique physical layer cell identifier, but different SSBs may have different physical layer cell identifiers.

The UE may acquire DL synchronization by detecting the SSB. The UE may identify the structure of the SSB burst set based on the detected SSB (time) index, and thus the UE may detect a symbol/slot/half-frame boundary. A frame/half-frame number to which the detected SSB belongs may be identified based on system frame number (SFN) information and half-frame indication information.

Specifically, the UE may obtain a 10-bit SFN for a frame to which a PBCH belongs from the PBCH. Then, the UE may obtain 1-bit half-frame indication information. For example, when the UE detects the PBCH in which the half-frame indication bit is set to 0, the UE may determine that an SSB to which the PBCH belongs is included in the first half-frame of the frame. When the UE detects the PBCH in which the half-frame indication bit is set to 1, the UE may determine that an SSB to which the PBCH belongs is included in the second half-frame of the frame. Finally, the UE may obtain the SSB index of the SSB to which the PBCH belongs based on a DMRS sequence and a PBCH payload carried by the PBCH.

After initial cell search, the UE may acquire more specific system information by receiving a physical downlink control channel (PDCCH) and receiving a physical downlink shared channel (PDSCH) based on information of the PDCCH in step S12.

System information (SI) is divided into a master information block (MIB) and a plurality of system information blocks (SIBs). The SI except for the MIB may be referred to as remaining minimum system information (RMSI). Details thereof will be described in the following.
The MIB includes information/parameters for monitoring a PDCCH scheduling a PDSCH carrying SIB1 (SystemInformationBlockl), and the MIB is transmitted by the BS over the PBCH of an SSB. For example, the UE may check based on the MIB whether there is a CORESET for a Type0-PDCCH common search space. The Type0-PDCCH common search space is a kind of PDCCH search space, which is used to transmit a PDCCH scheduling an SI message. If the Type0-PDCCH common search space exists, the UE may determine (1) a plurality of contiguous RBs and one or more consecutive symbols included in the CORESET and (ii) a PDCCH occasion (e.g., a time-domain location for PDCCH reception, based on information (e.g., pdcch-ConfigSIB1) in the MIB. If the Type0-PDCCH common search space does not exist, pdcch-ConfigSIB1 provides information on a frequency location at which the SSB/SIB1 exists and information on a frequency range where there are no SSB/SIB1.
SIB1 includes information related to availability and scheduling (e.g., transmission periodicity, SI-window size, etc.) of the remaining SIBs (hereinafter referred to as SIBx where x is an integer more than or equal to 2). For example, SIB1 may indicate whether SIBx is periodically broadcast or provided at the request of the UE in an on-demand manner. When SIBx is provided in an on-demand manner, SIB1 may include information necessary for the UE to send an SI request. SIB1 is transmitted over a PDSCH, and a PDCCH scheduling SIB1 is transmitted in the Type0-PDCCH common search space. That is, SIB1 is transmitted over the PDSCH indicated by the PDCCH.
SIBx is included in the SI message and transmitted on the PDSCH. Each SI message is transmitted within a periodically occurring time window (i.e., SI-window).

The UE may perform a random access procedure (e.g., 4-step RA procedure) to access the BS in steps S13 to S16. For random access, the UE may transmit a preamble to the BS on a physical random access channel (PRACH) (S13) and receive a response message for preamble on a PDCCH and a PDSCH corresponding to the PDCCH (S14). In the case of contention-based random access, the UE may perform a contention resolution procedure by further transmitting the PRACH (S15) and receiving a PDCCH and a PDSCH corresponding to the PDCCH (S16).

Hereinafter, a 2-step random access procedure will be described in brief. In the 2-step random access procedure, S13/S15 may be performed in one step (where the UE performs transmission) (message A), and S14/S16 may be performed in one step (where the BS performs transmission) (message B). Message A (MsgA) may include a preamble and a payload (PUSCH payload), and the preamble and payload may be multiplexed based on time division multiplexing (TDM). In response to MsgA, message B (MsgB) may be transmitted for contention resolution, fallback indication(s), and/or backoff indication. The 2-step random access procedure may be subdivided into a contention-based random access (CBRA) procedure and a contention-free random access (CFRA) procedure. In the CFRA procedure, the BS may provide the UE with information on a preamble that the UE needs to transmit in MsgA and information on PUSCH allocation before the UE transmits MsgA.

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

The MR system may support signal transmission/reception in unlicensed bands. According to regional regulations for unlicensed bands, a communication node in an unlicensed band needs to determine whether a channel is used by other communication node(s) before transmitting a signal. Specifically, the communication node may perform carrier sensing (CS) before transmitting the signal so as to check whether the other communication node(s) perform signal transmission. When it is determined that the other communication node(s) perform no signal transmission, it is said that clear channel assessment (CCA) is confirmed. When a CCA threshold is predefined or configured by higher layer signaling (e.g., RRC signaling), the communication node may determine that the channel is busy if the detected channel energy is higher than the CCA threshold. Otherwise, the communication node may determine that the channel is idle. When it is determined that the channel is idle, the communication node may start the signal transmission in a UCell. The sires of processes described above may be referred to as Listen-Before-Talk (LBT) or a channel access procedure (CAP). The LBT and CAP may be interchangeably used in this document.

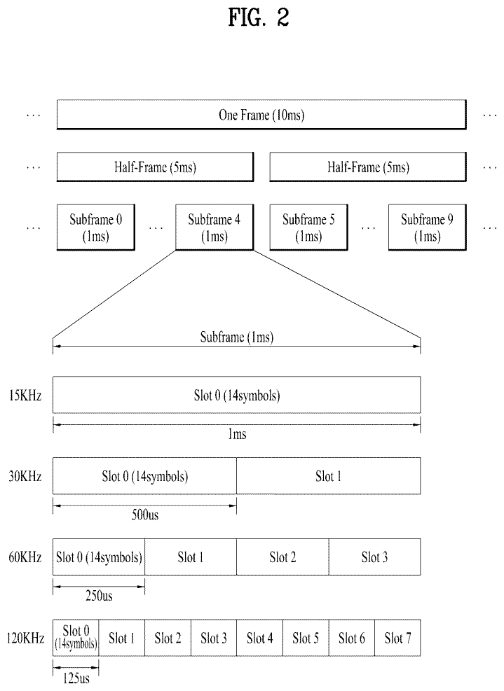

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame, u}ₛₗₒₜ: Number of slots in a frame
* N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

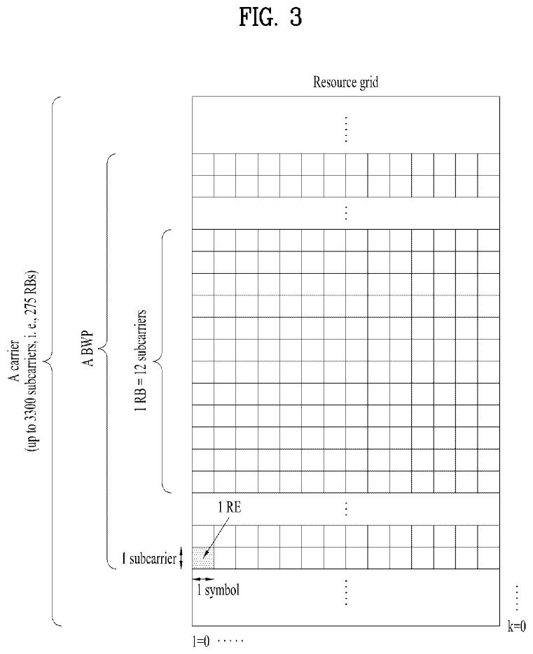

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

### Bandwidth Part (BWP)

In the NR system, up to 400 MHz may be supported per carrier. The network may instruct the UE to operate only in a part of the bandwidth of a wideband carrier, not the entire bandwidth, and the part of the bandwidth is called a bandwidth part (BWP). One or more BWPs may be configured in a carrier. In the frequency domain, a BWP is a subset of contiguous common resource blocks defined for a numerology in the bandwidth part on the carrier, and a numerology (e.g., subcarrier spacing, CP length, or slot/mini-slot duration) may be configured.

Activation/deactivation of DL/UL BWP or BWP switching may be performed based on network signaling and/or a timer (e.g., L1 signaling as a physical layer control signal, MAC control element (CE) as a MAC layer control signal, or RRC signaling, etc.). When the UE is in the initial access process or before the RRC connection of the UE is configured, the UE may not receive configuration for DL/UL BWP. In this case, the DL/UL BWP assumed by the UE is called an initially active DL/UL BWP.

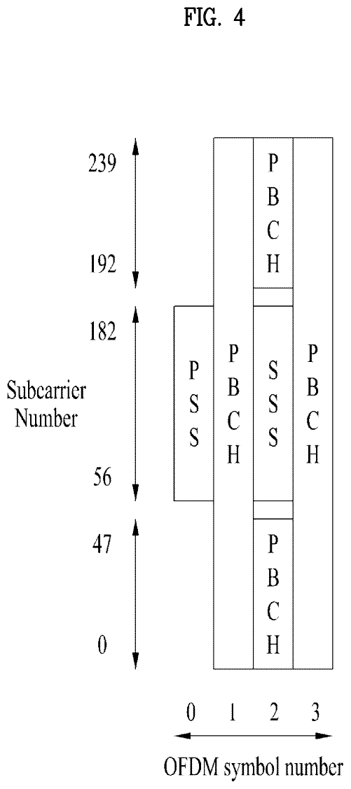

FIGS. 4 and 5 are drawings for explaining the structure and transmission method of an SSB (Synchronization Signal Block).

The UE may perform cell search, system information acquisition, beam alignment for initial access, DL measurement, and the like based on the SSB. Terms SSB the synchronization signal/physical broadcast channel (SS/PBCH) block will be interchangeably used.

Referring to FIG. 4, the SSB includes a PSS, an SSS, and a PBCH. The SSB includes four consecutive OFDM symbols, and the PSS, the PBCH, the SSS/PBCH, and the PBCH are transmitted in the respective OFDM symbols. Each of the PSS and the SSS includes one OFDM symbol by 127 subcarriers, and the PBCH includes three OFDM symbols by 576 subcarriers. Polar coding and QPSK are applied to the PBCH. The PBCH includes data REs and demodulation reference signal (DMRS) REs in every OFDM symbol. There are three DMRS REs per RB, with three data REs between every two adjacent DMRS REs.

Cell search is a process of acquiring time/frequency synchronization with a cell and detecting the identifier (ID) (e.g., physical cell ID (PCID)) of the cell. The PSS is used to detect a cell ID in a cell ID group, and the SSS is used to detect the cell ID group. The PBCH is used to detect an SSB (time) index and a half-frame.

The cell search process of the UE may be summarized in Table 3.

TABLE 3

| | Type of | |
|---|---|---|
| | Signals | Operations |
| 1st Step | PSS | *SS/PBCH block (SSB) symbol timing |
| | | acquisition* |
| | | Cell ID detection within a cell ID group (3 |
| | | hypothesis) |
| 2nd Step | SSS | Cell ID group detection (336 hypothesis) |
| 3rd Step | PBCH DMRS | * SSB index and Half frame (HF) index |
| | | (Slot and frame boundary detection) |
| 4th Step | PBCH | * Time information (80 ms, System Frame |
| | | Number (SFN), SSB index, HF)* |
| | | Remaining Minimum System Information |
| | | (RMSI) Control resource set |
| | | (CORESET)/Search Space configuration) |
| 5th Step | PDCCH and | * Cell access information* RACH |
| | PDSCH | configuration |

There may be 336 cell ID groups, each including three cell IDs. There may be 1008 cell IDs in total. Information about a cell ID group to which the cell ID of a cell belongs may be provided/obtained through the SSS of the cell, and information about the cell ID among 336 cells in the cell ID may be provided/obtained through the PSS.

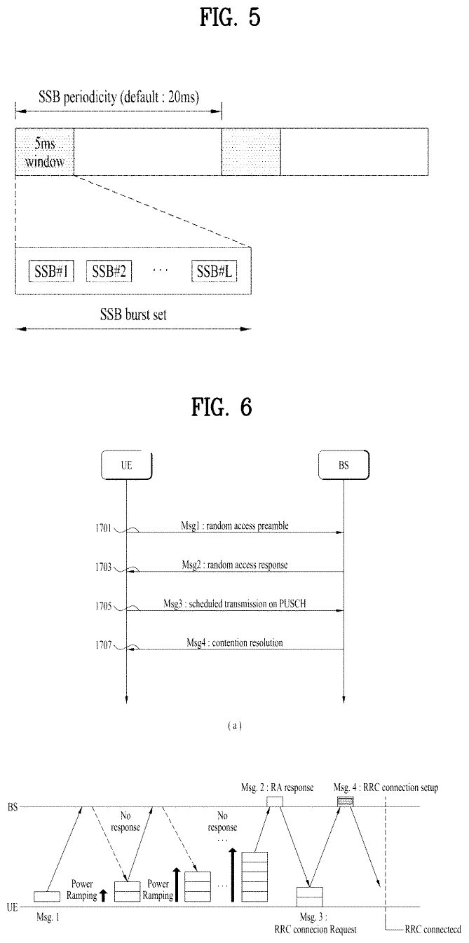

Referring to FIG. 6, an SSB is periodically transmitted according to an SSB periodicity. A basic SSB periodicity assumed by the UE in the initial cell search is defined as 20 ms. After cell access, the SSB periodicity may be set to one of {5 ms, 10 ms, 20 ms, 40 ms, 80 ms, 160 ms} by the network (e.g., the BS). An SSB burst set is configured at the beginning of an SSB period. The SSB burst set may be configured in a 5-ms time window (i.e., half-frame), and an SSB may be repeatedly transmitted up to L times within the SS burst set. The maximum number L of transmissions of the SSB may be given according to the frequency band of a carrier as follows. One slot includes up to two SSBs.
For frequency range up to 3 GHz, L=4
   For frequency range from 3 GHz to 6 GHz, L=8
   For frequency range from 6 GHz to 52.6 GHz, L=64

The time position of an SSB candidate in the SS burst set may be defined according to an SCS as follows. The time positions of SSB candidates are indexed as (SSB indexes) 0 to L-1 in temporal order within the SSB burst set (i.e., half-frame).
Case A: 15-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case B: 30-kHz SCS: The indexes of the first symbols of candidate SSBs are given as {4, 8, 16, 20}+28*n where n=0 for a carrier frequency equal to or lower than 3 GHz, and n=0, 1 for a carrier frequency of 3 GHz to 6 GHz.
Case C: 30-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case D: 120-kHz SCS: The indexes of the first symbols of candidate SSBs are given as {4, 8, 16, 20}+28*n where n=0, 1, 2, 3, 5, 6, 7, 8, 10, 11, 12, 13, 15, 16, 17, 18 for a carrier frequency above 6 GHz.
Case E: 240-kHz SCS: The indexes of the first symbols of candidate SSBs are given as {8, 12, 16, 20, 32, 36, 40, 44}+56*n where n=0, 1, 2, 3, 5, 6, 7, 8 for a carrier frequency above 6 GHz.

### Bandwidth Part (BWP)

The NR system may support up to 400 MHz for each carrier. The network may instruct the UE to operate only in a partial bandwidth rather than the whole bandwidth of such a wideband carrier. The partial bandwidth is referred to as a BWP. The BWP refers to a subset of contiguous common RBs defined for a numerology in the BWP of a carrier in the frequency domain, and one numerology (e.g., SCS, CP length, slot/mini-slot duration, etc.) may be configured.

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signaling, etc.). The BS may instruct the UE to switch to another configured DL/UL BWP (through L1 signaling, MAC CE or RRC signaling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

FIG. 6 illustrates an exemplary normal random access procedure. Specifically, FIG. 6 shows a contention-based random access procedure of the UE, which is performed in four steps.

First, the UE may transmit message 1 (Msg1) including a random access preamble on a PRACH (see 1701 of FIG. 6(a)).

Random access preamble sequences with different lengths may be supported. A long sequence length of 839 may be applied to SCSs of 1.25 and 5 kHz, and a short sequence length of 139 may be applied to SCSs of 15, 30, 60, and 120 kHz.

Multiple preamble formats may be defined by one or more RACH OFDM symbols and different CPs (and/or guard times). A RACH configuration for a cell may be included in SI about the cell and provided to the UE. The RACH configuration may include information on the SCS of the PRACH, available preambles, preamble formats, and so on. The RACH configuration may include information about association between SSBs and RACH (time-frequency) resources. The UE transmits a random access preamble on a RACH time-frequency resource associated with a detected or selected SSB.

The threshold of an SSB for RACH resource association may be configured by the network, and a RACH preamble may be transmitted or retransmitted based on an SSB where reference signal received power (RSRP), which is measured based on the SSB, satisfies the threshold. For example, the UE may select one SSB from among SSBs that satisfy the threshold and transmit or retransmit the RACH preamble based on a RACH resource associated with the selected SSB.

Upon receiving the random access preamble from the UE, the BS may transmit message 2 (Msg2) corresponding to a random access response (RAR) message to the UE (see 1703 of FIG. 6(a)). A PDCCH scheduling a PDSCH carrying the RAR may be CRC masked with a random access (RA) radio network temporary identifier (RNTI) (RA-RNTI) and then transmitted. Upon detecting the PDCCH masked by the RA-RNTI, the UE may obtain the RAR from the PDSCH scheduled by DCI carried by the PDCCH. The UE may check whether the RAR includes RAR information in response to the preamble transmitted by the UE, i.e., Msg1. The presence or absence of the RAR information in response to Msg1 transmitted by the UE may be determined depending on whether there is a random access preamble ID for the preamble transmitted by the UE. If there is no response to Msg1, the UE may retransmit the RACH preamble within a predetermined number of times while performing power ramping. The UE may calculate PRACH transmit power for retransmitting the preamble based on the most recent path loss and power ramping counter.

The RAR information transmitted on the PDSCH may include timing advance (TA) information for UL synchronization, an initial UL grant, and a temporary cell-RNTI (C-RNTI). The TA information may be used to control a UL signal transmission timing. The UE may transmit a UL signal over a UL shared channel as message 3 (Msg3) of the random access procedure based on the RAR information (see 1705 of FIG. 6(a)). Msg3 may include an RRC connection request and a UE identifier. In response to Msg3, the network may transmit message 4 (Msg4), which may be treated as a contention resolution message on DL (see 1707 of FIG. 6(a)). Upon receiving Msg4, the UE may enter the RRC_CONNECTED state.

On the other hand, a contention-free random access procedure may be performed when the UE is handed over to another cell or BS or when it is requested by the BS. In the contention-free random access procedure, a preamble to be used by the UE (hereinafter referred to as a dedicated random access preamble) is allocated by the BS. Information on the dedicated random access preamble may be included in an RRC message (e.g., handover command) or provided to the UE through a PDCCH order. When the random access procedure is initiated, the UE may transmit the dedicated random access preamble to the BS. When the UE receives an RAR from the BS, the random access procedure is completed.

As described above, a UL grant in the RAR may schedule PUSCH transmission to the UE. A PUSCH carrying initial UL transmission based on the UL grant in the RAR is referred to as an Msg3 PUSCH. The content of an RAR UL grant may start at the MSB and end at the LSB, and the content may be given as shown in Table 4.

TABLE 4

| RAR UL grant field | Number of bits |
|---|---|
| Frequency hopping flag | 1 |
| Msg3 PUSCH frequency resource allocation | 12 |
| Msg3 PUCH time resource allocation | 4 |
| Modulation and coding scheme (MCS) | 4 |
| Transmit power control (TPC) for Msg3 PUSCH | 3 |
| CSI request | 1 |

In a contention-free random access (CFRA) procedure, the CSI request field in the RAR UL grant indicates whether the terminal includes aperiodic CSI reporting in the corresponding PUSCH transmission. a subcarrier spacing for Msg3 PUSCH transmission is provided by the RRC parameter. The terminal may transmit PRACH and Msg3 PUSCH on the same uplink carrier in the same service providing cell. A UL BWP for Msg3 PUSCH transmission is indicated by SystemInformationBlockl (SIB1).

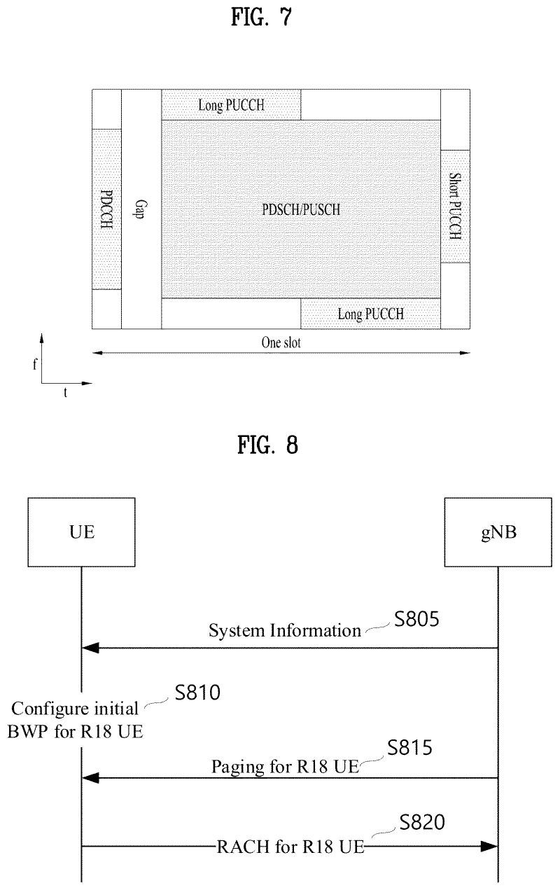

FIG. 7 illustrates exemplary mapping of physical channels in a slot.

Referring to FIG. 7, a PDCCH may be transmitted in a DL control region, and a PDSCH may be transmitted in a DL data region. A PUCCH may be transmitted in a UL control region, and a PUSCH may be transmitted in a UL data region. A guard period (GP) provides a time gap for transmission mode-to-reception mode switching or reception mode-to-transmission mode switching at a BS and a UE. Some symbol at the time of DL-to-UL switching in a subframe may be configured as a GP.

Each physical channel will be described below in greater detail.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH includes 1, 2, 4, 8, or 16 control channel elements (CCEs) according to its aggregation level (AL). A CCE is a logical allocation unit used to provide a PDCCH with a specific code rate according to a radio channel state. A CCE includes 6 resource element groups (REGs), each REG being defined by one OFDM symbol by one (P)RB. The PDCCH is transmitted in a control resource set (CORESET). A CORESET is defined as a set of REGs with a given numerology (e.g., an SCS, a CP length, and so on). A plurality of CORESETs for one UE may overlap with each other in the time/frequency domain. A CORESET may be configured by system information (e.g., a master information block (MIB)) or UE-specific higher-layer signaling (e.g., radio resource control (RRC) signaling). Specifically, the number of RBs and the number of symbols (3 at maximum) in the CORESET may be configured through higher-layer signaling.

For PDCCH reception/detection, the UE monitors PDCCH candidates. A PDCCH candidate is CCE(s) that the UE should monitor to detect a PDCCH. Each PDCCH candidate is defined as 1, 2, 4, 8, or 16 CCEs according to an AL. The monitoring includes (blind) decoding PDCCH candidates. A set of PDCCH candidates decoded by the UE are defined as a PDCCH search space (SS). An SS may be a common search space (CSS) or a UE-specific search space (USS). The UE may obtain DCI by monitoring PDCCH candidates in one or more SSs configured by an MIB or higher-layer signaling. Each CORESET is associated with one or more SSs, and each 55 is associated with one CORESET. An SS may be defined based on the following parameters.
controlResourceSetId A CORESET related to an SS.
monitoringSlotPeriodicityAndOffset: A PDCCH monitoring periodicity (in slots) and a PDCCH monitoring offset (in slots).
monitoringSymbolsWithinSlot: PDCCH monitoring symbols in a slot (e.g., the first symbol(s) of a CORESET).
nrofCandidates: The number of PDCCH candidates (one of 0, 1, 2, 3, 4, 5, 6, and 8) for each AL={1, 2, 4, 8, 16}.
An occasion (e.g., time/frequency resources) in which the UE is to monitor PDCCH candidates is defined as a PDCCH (monitoring) occasion. One or more PDCCH (monitoring) occasions may be configured in a slot.

Table 5 shows the characteristics of each SS.

TABLE 5

| | Search | | |
|---|---|---|---|
| Type | Space | RNTI | Use Case |
| Type0-PDCCH | Common | SI-RNTI on a primary cell | SIB Decoding |
| Type0A- | Common | SI-RNTI on a primary cell | SIB Decoding |
| PDCCH | | | |
| Type1-PDCCH | Common | RA-RNTI or TC-RNTI on a | Msg2, Msg4 |
| | | primary cell | decoding in |
| | | | RACH |
| Type2-PDCCH | Common | P-RNTI on a primary cell | Paging |
| Type3-PDCCH | Common | INT-RNTI, SFI-RNTI, | Decoding |
| | | TPC-PUSCH-RNTI, TPC- | |
| | | PUCCH-RNTI, TPC-SRS- | |
| | | RNTI, C-RNTI, MCS-C- | |
| | | RNTI, or CS-RNTI(s) | |
| | UE | C-RNTI, or MCS-C-RNTI, | User specific |
| | Specific | or CS-RNTI(s) | PDSCH |
| | | | decoding |

Table 5 shows DCI formats transmitted on the PDCCH.

TABLE 6

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 10 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 11 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping may be performed on a codeword basis, and modulation symbols generated from each codeword may be mapped to one or more layers. Each layer together with a demodulation reference signal (DMRS) is mapped to resources, and an OFDM symbol signal is generated from the mapped layer with the DMRS and transmitted through a corresponding antenna port.

The PUCCH delivers uplink control information (UCI). The UCI includes the following information.
SR (Scheduling Request): Information used to request UL-SCH resources.
HARQ (Hybrid Automatic Repeat reQuest)-ACK (Acknowledgement): A response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.
CSI (Channel State Information): Feedback information for a DL channel. Multiple input multiple output (MIMO)-related feedback information includes an RI and a PMI.

The PUSCH delivers UL data (e.g., UL-shared channel transport block (UL-SCH TB)) and/or UCI based on a CP-OFDM waveform or a DFT-s-OFDM waveform. When the PUSCH is transmitted in the DFT-s-OFDM waveform, the UE transmits the PUSCH by transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. A PUSCH transmission may be dynamically scheduled by a UL grant in DCI, or semi-statically scheduled by higher-layer (e.g., RRC) signaling (and/or Layer 1 (L1) signaling such as a PDCCH) (configured scheduling or configured grant). The PUSCH transmission may be performed in a codebook-based or non-codebook-based manner.

### Narrower DL BWP for System Information and Paging

In addition to the recent 5G main use cases (mMTC, eMBB, and URLLC), the importance/interest in use case areas spanning mMTC and eMBB, or mMTC and URLLC, has increased. These use cases may include connected industries, smart cities, and wearables. To support the use cases more efficiently in terms of terminal cost/complexity, and power consumption in a wireless communication system, a new type of terminal that is distinct from the conventional NR terminal has been introduced. This new type of terminal is called Reduced Capability NR terminal (hereinafter referred to as RedCap UE/terminal, or RedCap), and to distinguish the new type of terminal from the conventional NR terminal, the existing NR terminal is called non-RedCap UE/terminal, or non-RedCap. The RedCap terminal is more inexpensive and has lower power consumption than the non-RedCap terminal, and in detail, may have all or some of the following features.

### A. Complexity Reduction Related Features:

Reduced maximum UE Bandwidth
Reduced number of UE RX/TX branches/antennas
Half-Duplex-FDD
Relaxed UE processing time
Relaxed UE processing capability

### B. Power Saving Related Features:

Extended DRX for RRC inactive and/or idle
RRM relaxation for stationary devices
Target use cases for the Redcap terminal with the features may include:

### 1) Connected Industries

Sensors and actuators connected to 5G network and core
massive Industrial Wireless Sensor Network (IWSN)
Relatively low-cost service that requires small device form factor with battery life of several years, as well as URLLC service with very high requirements.
The requirements for this service are higher than Low Power Wide Area (LPWA) (i.e., LTE-M/NB-IOT) but lower than URLCC and eMBB.
Pressure sensor, humidity sensor, thermometer, motion sensor, accelerometer, actuator, and the like

### 2) Smart City

Data collection and processing to monitor and control urban resources more efficiently and provide services
Necessary surveillance camera for smart city as well as factory and industrial complex

### 3) Wearables

Smart watch, ring, eHealth related device, medical monitoring device, and the like
Small device, and the like

The RedCap UE may have lower transmit and receive performance than the non-RedCap terminal. The main cause is decrease in frequency diversity performance due to a decrease in terminal bandwidth, and decrease in performance may become greater as a supported terminal bandwidth decreases.

Considering RedCap main use cases such as wearables and massive wireless sensors, massive connections need to be supported through a narrow bandwidth, and thus traffic congestion problems are expected.

To resolve the problems, a method that supports terminal frequency hopping (hereinafter FH) and traffic offloading (hereinafter TO) is proposed.

In this specification, ‘( )’ may be interpreted both as excluding the contents within 0 and as including the contents within the parentheses. In this specification, ‘/’ may mean including all of the contents separated by / (and) or including only some of the separated contents (or).

### A Plurality of RedCap UE Types and BWP Modes

The following different RedCap UE types are supported in this specification. In particular, at least the following two types are supported.
(1) Rel.17 RedCap UE (hereinafter, Rel.17 R-UE): Rel.17 R-UE supporting BWP of 20 MHz
(2) Rel.18 RedCap UE (hereinafter, Rel.18 R-UE): Rel.18 R-UE supporting BWP of 5 MHz (or sub-BWP of 5 MHz or BW location of 5 MHz).
1) Option BW1: Both RF and BaseBand (BB) bandwidths of UE support 5 MHz for UL/DL.
2) Option BW2: The UE supports BB bandwidth of 5 MHz and RF bandwidth of 20 MHz for all UL/DL signals/channels.
3) Option BW3: Only BB bandwidth of 5 MHz is supported for PDSCH (unicast/broadcast PDSCH) and PUSCH, and RF bandwidth of 20 MHz is supported for UL/DL. However, up to UE RF of 20 MHz+BB bandwidth is supported for other physical channels and signals.

In this specification, Rel.18 PDSCH or DCI may mean PDSCH or DCI for Rel.18 R-UE. Rel-17 PDSCH or legacy PDSCH or pre-Rel. 18 PDSCH may mean a PDSCH for a Rel. 17 R-UE or a non-RedCap UE regardless of release, and Rel-17 DCI or legacy DCI or pre-Rel. 18 DCI may mean DCI for an Rel. 17 R-UE or a non-RedCap UE regardless of release.

In this specification, the BWP for Rel.18 R-UE may be replaced by a sub-BWP or a BW location, and may have a size of 5 MHz or less.

FIG. 8 shows a flow of a signal transmission and reception method according to one embodiment.

Referring to FIG. 8, the UE may receive system information (805). The UE may configure an initial BWP (810). The UE may receive a paging signal from a BS (815) and perform a RACH procedure for initial access from the BS (820).

In detail, the UE may usually configure/activate one initial BWP when in RRC_IDLE or RRC_INACTIVE state, and perform the initial access procedure/process through the initial BWP in the activated state. For the R18 RedCap UE, the BS may allocate a PDSCH by dividing the initial BWP for a normal UE and/or the R17-initial BWP for the R17 RedCap UE into N BWPs of 5 MHz. For example, when an R18 RedCap UE is capable of only receiving PDSCH transmissions up to 5 MHz, an initial BWP of 20 MHz may be divided into N sub-BWPs of 5 MHz and Rel-18 PDSCH(s) may be transmitted through one or more specific sub-BWPs of 5 MHz of the initial BWP of 20 MHz for system information transmission and/or paging transmission.

The R18 RedCap UE may be explicitly configured with a plurality of sub-BWPs of 5 MHz separated within an initial BWP of 20 MHz or an initial BWP for a normal UE, or may be allocated a frequency resource corresponding to a sub-BWP (hereinafter, bandwidth) of 5 MHz within an initial BWP of 20 MHz or the initial BWP for the normal UE without explicitly separated configuration for a plurality of sub-BWPs of 5 MHz. Hereinafter, for convenience of explanation, it is assumed that the R18 RedCap UE is configured with a plurality of sub-BWPs of 5 MHz separated within a specific BWP, but the present disclosure is not limited thereto, and it may also be applied to a case in which a sub-BWP 5 MHz or a frequency bandwidth of 5 MHz is indicated through a resource allocation method without explicitly separated configuration.

### Method of Configuring One or More Sub-BWPs

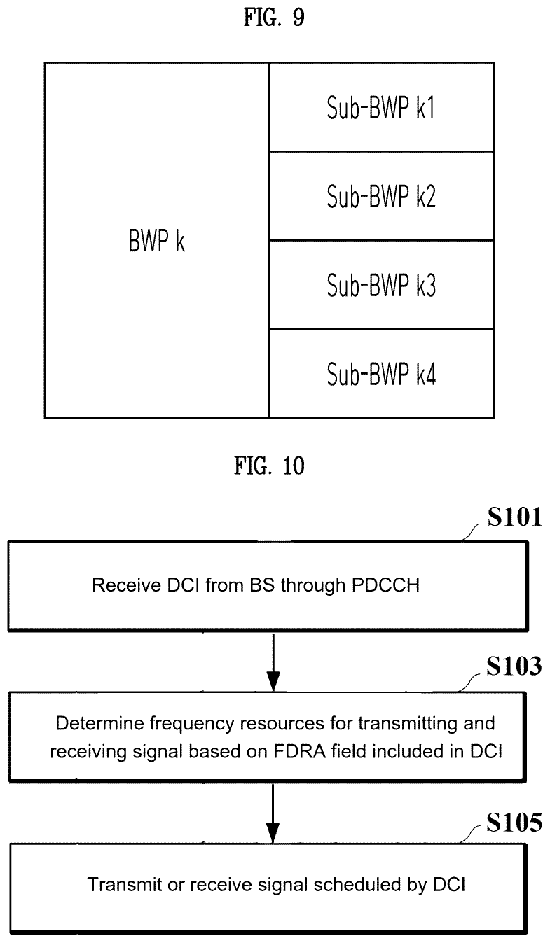

FIG. 9 is a diagram for explaining a method of configuring a plurality of sub-BWPs in one BWP.

Referring to FIG. 9, a UE in RRC_CONNECTED state may have up to four UE-dedicated BWPs (or sub-BWPs) configured for one BWP. In this case, the UE may activate only one sub-BWP from among the four sub-BWPs. For example, a BS may configure up to N sub-BWPs for a specific BWP k for a UE. (N=1, 2, 3, 4 . . . ). In this case, the sub-BWPs may be configured to not overlap each other (non-overlapped sub-BWPs) as shown in FIG. 9, or may be configured to overlap in entirely/partially.

For example, when the one BWP is a BWP of 8 MHz, the sub-BWPs may be configured as a sub-BWP of 5 MHz and a sub-BWP of 3 MHz not to overlap each other within 8 MHz. Alternatively, the sub-BWPs may be configured as a sub-BWP of 4 Mhz and a sub-BWP of 4 Mhz that do not overlap each other within a BWP of 8 Mhz, or as a sub-BWP of 5 Mhz and a sub-BWP of 5 Mhz that partially overlap each other. In this case, each sub-BWP may be configured in the following method.
(1) Method 1: A BS may indicate a starting PRB and the number of PRBs (consecutive PRBs) for each sub-BWP. The starting PRB of a sub-BWP may be indicated/configured via a relative offset to the starting PRB of a specific BWP connected to the sub-BWP.
(2) Method 2: A BS may configure sub-BWPs according to a value of N by indicating the number of sub-BWPs N for a specific BWP. When M PRBs constituting a specific BWP are divided into N sub-BWPs, each sub-BWP may be configured to include PRBs equal to the Ceiling (M/N) or Floor (M/N) value.
For example, each sub-BWP may include PRBs corresponding to the number of PRBs calculated based on Ceiling (M/N). For example, when M=5 and N=2, Ceiling (M/N)=3, and thus each sub-BWP includes three PRBs, and from among five PRBs of a specific BWP, the lower three PRBs (i.e., the three PRBs with relatively low PRB indices) are allocated to the first sub-BWP, and the upper three PRBs (i.e., the three PRBs with relatively high PRB indices) are allocated to the second sub-BWP. In this case, the third PRB of the specific BWP may be configured as a frequency resource in which two sub-BWPs overlap each other.
Each sub-BWP may include PRBs corresponding to the number of PRBs calculated based on Floor (M/N). For example, when M=5 and N=2, Floor (M/N)=2, and thus each sub-BWP includes two PRBs, and from among five PRBs of a specific BWP, the lower two PRBs (i.e., the two PRBs with relatively low PRB indices) are allocated to the first sub-BWP, and the upper two PRBs (i.e., the two PRBs with relatively high PRB indices) are allocated to the second sub-BWP. In this case, the third PRB of the specific BWP may be configured as a guard frequency resource (or guard band) that does not belong to any sub-BWP.

For example, when two or more sub-BWPs are configured for a specific BWP, a specific sub-BWP from among the two or more sub-BWPs may be determined/indicated as a first active sub-BWP (or default sub-BWP, initial sub-BWP, default BW location, or associated sub-BWP) through an RRC message (or, MAC CE, or DCI). Here, the specific BWP and the specific sub-BWP may be a specific BWP and/or a specific sub-BWP for DL and/or UL. As such, when the first active sub-BWP for a specific BWP of a specific cell is configured, the UE may activate/configure the first active sub-BWP of the specific BWP or switch to the first active sub-BWP of the specific BWP. Then, the UE may transmit a PUSCH in the first active sub-BWP indicated/configured for a specific UL BWP and receive a PDCCH and/or a PDSCH in the first active sub-BWP indicated/configured for a specific DL BWP.

### DCI Indication-Based Sub-BWP Change Method

When a BS configures two or more sub-BWPs for a specific BWP for a specific cell, the BS may change an old sub-BWP (existing sub_BWP) to anew sub-BWP (new BW location, or new associated sub-BWP) through an RRC message, a MAC CE, or DCI. In this case, the RRC message, MAC CE or DCI may indicate an index of the new sub-BWP. For example, when four sub-BWPs are configured for the specific BWP via the RRC message, the BS may configure an index for each sub-BWP via the RRC message or RRC signaling. Alternatively, when the BS does not indicate/configure an index for each sub-BWP, a UE may allocate/configure an index for each sub-BWP from the lowest or highest index according to the configuration order of the sub-BWPs.

Then, the UE may transmit a PUSCH in a first active sub-BWP indicated/configured for a specific UL BWP (via RRC message, MAC CE or DCI), and receive a PDCCH and/or a PDSCH in the indicated/configured first active sub-BWP of a specific DL BWP.

Alternatively, in the case of scheduling DCI for scheduling a PDSCH or a PUSCH, the UE may transmit the PUSCH or receive the PDSCH in a specific sub-BWP for a specific BWP indicated by the scheduling DCI. In this case, the indicated specific sub-BWP may be the same as or different from the sub-BWP in which the UE previously transmits a PSUCH or receives a PDSCH.
When the scheduling DCI does not indicate a separate sub-BWP, the UE may transmit a PUSCH or receive a PDSCH in the sub-BWP specified/configured via the RRC message or MAC CE. For example, the sub-BWP specified/configured via the RRC message or MAC CE may be the first active sub-BWP.
Alternatively, when the scheduling DCI does not indicate a separate sub-BWP, the UE may select a sub-BWP in which the PUSCH is transmitted or the PDSCH is received immediately or previously (or based on a sub-BWP indicated by the previous scheduling DCI) to transmit the scheduled PUSCH or receive the PDSCH.
Alternatively, when the scheduling DCI does not indicate a separate sub-BWP, the UE may select the first activated sub-BWP when activating the specific BWP to transmit the scheduled PUSCH or receive the PDSCH.

Alternatively, when the DCI is a non-scheduling DCI that does not schedule a PDSCH/PUSCH, the UE may transmit a PUSCH (scheduled by another scheduling DCI) or receive a PDSCH in a specific sub-BWP of a specific BWP indicated by the non-scheduling DCI in the future. Alternatively, the UE may transmit a PUSCH or receive a PDSCH scheduled through another scheduling DCI, or the like after receiving the non-scheduling DCI in a specific sub-BWP for the specific BWP indicated by the non-scheduled DCI. In this case, when the non-scheduling DCI indicates a PUCCH resource, the UE may transmit an acknowledgment (confirmation) ACK for the specific sub-BWP indicated by the non-scheduling DCI through the PUCCH resource in the specific sub-BWP of the specific BWP indicated by the non-scheduling DCI. In this case, the specific sub-BWP indicated (via non-scheduling DCI) may be the same as or different from the sub-BWP in which the UE previously transmits a PSUCH or receives a PDSCH.
When the non-scheduling DCI does not indicate a separate sub-BWP, the UE may transmit the PUCCH (or the PUCCH including information on acknowledgment of reception of the non-scheduling DCI) in the sub-BWP specified by the RRC message or MAC CE. For example, the sub-BWP specified via the RRC message or MAC CE may be the first active sub-BWP.
Alternatively, when the non-scheduling DCI does not indicate a separate sub-BWP, the UE may select a sub-BWP in which a PUSCH or PUCCH is transmitted (or a PDSCH is received) immediately before or previously and transmit a PUCCH (or a PUCCH including information on acknowledgment of reception of the non-scheduling DCI).
Alternatively, when the non-scheduling DCI does not indicate a separate sub-BWP, the UE may select the first activated sub-BWP when activating the specific BWP to transmit the PUCCH (or the PUCCH including information on the acknowledgment of reception of the non-scheduling DCI).

The scheduling DCI or non-scheduling DCI may be DCI that indicates BWP switching to the specific BWP. Alternatively, the scheduling DCI or non-scheduling DCI may indicate a specific operation in the specific BWP without indication of BWP switching. For example, the scheduling DCI or non-scheduling DCI may be DCI that indicates activation/deactivation of semi persistent scheduling (SPS) or configured grant (CG) in the specific BWP. When DCI indicating a specific sub-BWP for the specific BWP activates/deactivates SPS or CG in the specific BWP, the BS and the UE may activate or deactivate SPS PDSCH reception or CG PUSCH transmission in the specific sub-BWP for the specific BWP.

When switching from an old sub-BWP to a new sub-BWP according to the indication of the DCI, the UE may transmit the PUSCH/PUCCH or receive the PDSCH only when a specific time interval is ensured after a time point of receiving the DCI. Taking this into consideration, the UE may report UE capability information about a minimum or maximum time interval that the UE is capable of supporting, to the BS. In this case, the BS may configure the specific time interval based on the capability information.
For example, when transmission of a PUSCH/PUCCH or reception of a PDSCH is scheduled after a specific time interval from the time of reception of the scheduling DCI or non-scheduling DCI indicating the new sub-BWP, the UE may transmit the PUSCH/PUCCH or receive the PDSCH in the indicated new sub-BWP, as described above.
Conversely, when transmission of a PUSCH/PUCCH or reception of a PDSCH is scheduled prior to a specific time interval from the reception time of the scheduling DCI or non-scheduling DCI indicating the new sub-BWP, the UE may transmit the PUSCH/PUCCH or receive the PDSCH in the old sub-BWP. Alternatively, when the UE is scheduled to transmit the PUSCH/PUCCH or receive the PDSCH prior to a specific time interval from the time of reception of the scheduling DCI or non-scheduling DCI indicating the new sub-BWP, the UE may not transmit the PUSCH or PUCCH or may not receive the PDSCH. Alternatively, the UE may expect that the UE is not be scheduled to transmit a PUSCH/PUCCH or receive a PDSCH prior to a specific time interval from the time of reception of the scheduling DCI or non-scheduling DCI indicating the new sub-BWP.

### DCI Resource-Based Sub-BWP Change Method

When the sub-BWP is determined according to the DCI, the UE may determine the sub-BWP (e.g., BW location of 5 Mhz) based on a resource location of the received DCI as follows.

1. Method 1: Method in which a Sub-BWP is Determined Based on a CORESET or Search Space (SS) in which DCI is Received

The BS may connect/map at least one sub-BWP to a specific CORESET ID or SS ID. Alternatively, the BS may connect/map at least one CORESET ID or SS ID to a specific sub-BWP. When the sub-BWP is mapped/configured as such, the UE may allocate the PDSCH or PUSCH resource scheduled by the DCI within the sub-BWP mapped/connected to the specific CORESET ID or SS ID in which the DCI is received.

In this method, when the DCI is transmitted/received in the same slot as the PDSCH, the UE is not capable of recognizing the corresponding sub-BWP before receiving the DCI and thus may have a difficulty in buffering the PDSCH scheduled by the DCI. Therefore, the UE may expect that the first method is applied only to inter-slot PDSCH/PUSCH scheduling.

2. Method 2: Method in which a Sub-BWP is Determined Based on an Allocation Location of a Control Channel Element (CCE) of DCI

The BS may connect/map at least one sub-BWP to a specific CCE. Alternatively, the BS may connect/map at least one CCE to a specific sub-BWP. In this case, the UE may allocate PDSCH or PUSCH resources scheduled by the DCI within a sub-BWP connected/mapped to a specific CCE related to the received DCI.

For example, when a PDCCH aggregation level of the DCI received by the UE is 1, the number of CCEs related to the DCI is 1, and thus the UE may receive the PDSCH scheduled by the DCI or transmit the PUSCH within the sub-BWP connected to the CCE.

Alternatively, when the PDCCH aggregation level of the DCI received by the UE is 4, the number of CCEs related to the DCI is 4, and thus the UE may receive the PDSCH scheduled by the DCI or transmit the PUSCH within the sub-BWP connected to the lowest or highest CCE in the frequency axis (or based on the RB/frequency index) from among the 4 CCEs.

3. Method 3: Method in which a Sub-BWP is Determined Based on a Location of a Time Resource in which DCI is Received

The UE may determine/specify a frequency period of 5 MHz or a frequency band of 5 MHz related to the DCI based on a symbol index, a slot index, a subframe index, and/or an SFN index as follows.
The BS may connect/map a specific symbol index, a specific slot index, a specific subframe index, and/or a specific SFN index to at least one sub-BWP. Alternatively, the BS may connect/map a specific sub-BWP to at least one specific slot index, a specific subframe index, and/or a specific SFN index. In this case, the UE may allocate a PDSCH or PUSCH resource scheduled by the DCI within a specific sub-BWP mapped/connected to a specific symbol index, a specific slot index, a specific subframe index, and/or a specific SFN index in which the DCI is received. Alternatively, the UE may receive a PDSCH scheduled by the DCI or transmit the PUSCH within a specific sub-BWP mapped/connected to a specific symbol index, a specific slot index, a specific subframe index, and/or a specific SFN index in which the DCI is received.

In the third method, when a plurality of sub-BWPs are configured for the specific BWP, different sub-BWPs may be connected/mapped based on symbol index, a slot index, a subframe index, and/or an SFN index. For example, when DCI is received in a first slot of a first subframe, the UE may transmit a PUSCH scheduled by the DCI or receive a PDSCH in the first sub-BWP. When DCI is received in a second slot of a first subframe, the UE may transmit a PUSCH scheduled by the DCI or receive a PDSCH in the second sub-BWP. In this case, the UE may transmit a PSUCH or receive a PDSCH based on frequency hopping (while changing a sub-BWP).

### Method of Determining FDRA-Based Sub-BWP of DCI

When DCI indicates frequency domain resource allocation (FDRA) of a PDSCH and/or a PUSCH, a BS may allocate a PDSCH and/or a PUSCH (or frequency/time resources of PDSCH and/or PUSCH) within a specific sub-BWP (e.g., a specific 5 MHz) through the existing FDRA field without separate sub-BWP configuration or indication.

(1) when a Specific Sub-BWP is Configured/Indicated or not Configured/Indicated Via RRC Message, MAC CE and/or DCI

The following operations may be performed when a specific sub-BWP is configured/indicated via an RRC message, a MAC CE and/or DCI (or when the specific sub-BWP is not configured/indicated via an RRC message, MAC CE and/or DCI).
The UE may expect that the PDSCH and/or PUSCH resource allocation via the FDRA field of the DCI is allocated within a specific sub-BWP.
Alternatively, when the PDSCH and/or PUSCH resource allocation through the FDRA field of the DCI exceeds a specific sub-BWP, the UE may disregard the resource allocation exceeding the specific sub-BWP and receive the PDSCH or transmit the PUSCH by using only the resources within the specific sub-BWP. For example, when the FDRA field of the DCI allocates first frequency resources located within the specific sub-BWP and second frequency resources outside the specific sub-BWP, the UE may receive the PDSCH or transmit the PUSCH by using only the first frequency resources, and disregard the allocation of the second frequency resources.
Alternatively, when the FDRA field of the DCI allocates the PDSCH and/or PUSCH resources exceeding the frequency band size of the sub-BWP (5 MHz), the UE may receive the PDSCH or transmit the PUSCH by using only frequency resources located within the frequency band of the sub-BWP (5 MHz) from among the frequency resources allocated by the FDRA field. For example, when the FDRA field of the DCI allocates the frequency resources over a frequency band of 6 MHz, the UE may receive the PDSCH or transmit the PUSCH by using only 5 MHz of the frequency resources allocated for the 6 MHz, and disregard the frequency resources allocated for the remaining 1 MHz. For example, the UE may disregard frequency resources allocated within 1 MHz from the lowest-sized frequency resource (the lowest frequency resource index/RB index) from among the frequency resources allocated for 6 MHz, or may disregard frequency resources allocated within 1 MHz from the highest-sized frequency resource (the lowest frequency resource index/RB index) from among the frequency resources allocated for 6 MHz. In other words, the UE may receive the PDSCH or transmit the PUSCH by using frequency resources located within 5 MHz from a frequency resource of the lowest size from among the frequency resources allocated for 6 MHz, or the UE may receive the PDSCH or transmit the PUSCH by using frequency resources located within 5 MHz from a frequency resource of the highest size from among the frequency resources allocated for 6 MHz.

Alternatively, when the FDRA field of the DCI allocates resources of a PDSCH or a PUSCH beyond a specific sub-BWP, the UE may reallocate frequency resources allocated beyond the specific sub-BWP within the specific sub-BWP. In this case, the UE may receive a PDSCH or transmit a PUSCH by using the frequency resources allocated to the FDRA field and the reallocated frequency resources together within a specific sub-BWP. In this case, the reallocated frequency resources are reallocated in order from low to high in frequency from among the resources outside a specific sub-BWP, and are reallocated in order from low to high in frequency from among the resources not allocated within a specific sub-BWP.

### Method of Operating Separate Sub-BWP Inactivity Timer

When at least one sub-BWP is configured within a specific BWP, the UE may activate only one sub-BWP and operate at a time. The UE may configure a sub-BWP inactivity timer for each sub-BWP, and the sub-BWP inactivity timer may be operated as follows.
When a specific Cell is configured or activated, a sub-BWP inactivity timer for the first activated sub-BWP for the first activated BWP in the Cell may be started.
When a specific Cell is released or deactivated, the sub-BWP inactivity timer running for all sub-BWPs of the Cell may be stopped.
When a specific BWP is activated, the sub-BWP inactivity timer for the sub-BWP that is first activated in the specific BWP may be started.
When a specific BWP is deactivated, the sub-BWP inactivity timer running for all sub-BWPs of the specific BWP may be stopped.
When a specific sub-BWP is configured/activated, a sub-BWP inactivity timer for the specific sub-BWP may be started.
When a specific sub-BWP is released/deactivated, a sub-BWP inactivity timer for the specific sub-BWP may be stopped.
When scheduling DCI or non-scheduling DCI for the UE is received from a specific BWP (e.g., when DCI with a CRC scrambled with a C-RNTI of the UE is received in the specific BWP), a sub-BWP inactivity timer for a sub-BWP to which a PDCCH or a PDSCH resource or a PUSCH resource scheduled by the DCI belongs may be (re)started. Alternatively, the sub-BWP inactivity timer for the sub-BWP to which the PDCCH resource belongs may be (re)started. Alternatively, the sub-BWP inactivity timer may be (re)started for all sub-BWPs belonging to the specific BWP.
When an SPS PDSCH for the UE is received from a specific BWP or a CG PUSCH is transmitted, the sub-BWP inactivity timer for the sub-BWP to which the SPS PDSCH resource or CG PUSCH resource belongs may be (re)started. Alternatively, the sub-BWP inactivity timer for the sub-BWP to which the SPS PDCCH resource belongs may be (re)started. Alternatively, the sub-BWP inactivity timer may be (re)started for all sub-BWPs belonging to the specific BWP.
When a BWP inactivity timer of a specific BWP expires, the UE may stop sub-BWP inactivity timers running for at least one or all sub-BWPs belonging to the specific BWP.
When the SCell deactivation timer for a specific SCell expires, the UE may stop sub-BWP inactivity timers running for at least one or all sub-BWPs belonging to the Scell.

When the sub-BWP inactivity timer for an active sub-BWP for a specific BWP expires, the UE may switch to a (pre)determined/configured (default) sub-BWP for the specific BWP (e.g., lowest or highest BW of 5 Mhz, or first active sub-BWP or default sub-BWP configured by RRC).

### Frequency Hopping Method of BWP and Sub-BWP

A BS may separately configure an initial UL/DL BWP into a plurality of overlapped or non-overlapped sub-BWPs for a UE RRC_IDLE or RRC_INACTIVE state. The BS may separately configure one or more UL/DL BWPs for a UE in RRC_CONNECTED state into a plurality of overlapped or non-overlapped sub-BWPs.

As such, when an active BWP of the UE is separately configured into a plurality of overlapped or non-overlapped sub-BWPs, the UE may receive a PDCCH and/or a PDSCH and/or a reference signal from one sub-BWP for one BWP at a time (a specific time) through the plurality of sub-BWPs in the active DL BWP based on a specific frequency hopping pattern and may transmit a PUCCH and/or a PUSCH and/or a sounding reference signal (SRS) through one sub-BWP for one BWP at a time (a specific time) through the plurality of sub-BWPs in the active UL BWP based on the specific frequency hopping pattern. The UE in RRC_IDLE or RRC_INACTIVE state may select a sub-BWP (or an initial active sub-BWP) based on the frequency hopping pattern from an initial DL BWP, may receive paging, system information, or RACH MSG2/MSG4/MSGB, and may transmit RACH MSG1/MSGA/MSG3 by selecting a sub-BWP (or an initial active sub-BWP) based on the frequency hopping pattern from an initial UL BWP.

In a method based on the frequency hopping pattern, the frequency hopping pattern may include one or more of the following options.
The BS may transfer configuration information about one or more hopping patterns and an ID for each of the plurality of hopping patterns through an RRC message, and may transfer indication information indicating the ID of the hopping pattern to be applied through an RRC message (MAC CE or DCI). The UE may receive the configuration information, and when an ID is indicated through the indication information, the UE may perform the following operation.
When frequency hopping is not currently applied/executed, the UE may transmit and receive a signal based on the frequency hopping pattern of the indicated ID.
When frequency hopping is currently applied/executed, the UE may change the frequency hopping pattern of the indicated ID to a frequency hopping pattern and perform signal transmission/reception.
The transmission and reception operation of the signal may be performed based on the frequency hopping pattern according to the ID after a certain time immediately after receiving the ID. Here, the certain time may be designated/determined based on the UE capability or indicated/determined through an RRC configuration of the BS.
The BS and the UE may configure a pattern for frequency hopping a frequency period of 5 MHz or a frequency bandwidth of 5 MHz, which is a sub-BWP, based on a symbol index, a slot index, a subframe index, and/or an SFN index, as follows.
The BS may connect/map at least one BWP (and/or at least one sub-BWP) with a specific symbol index, a specific slot index, a specific subframe index, and/or a specific SFN index in the hopping pattern. Alternatively, the BS may connect/map a specific BWP and/or a specific sub-BWP to at least one symbol index, at least one slot index, at least one subframe index, and/or at least one SFN index. As such, by connecting different BWPs (and/or different sub-BWPs) for each symbol index, slot index, subframe index, and/or SFN index (in this pattern), the BS may configure a frequency hopping pattern for frequency hopping between BWPs (and/or sub-BWPs) over time. When the frequency hopping pattern is configured as such, the UE may be allocated a PDSCH or PUSCH resource scheduled by the DCI according to a sub-BWP connected to a specific symbol index, a specific slot index, a specific subframe index, and/or a specific SFN index based on the configured frequency hopping pattern.
For example, when the UE receives DCI in a first slot of a first subframe, the UE may transmit a PUSCH (or receive a PDSCH) scheduled by the DCI in a first sub-BWP of the first BWP. Alternatively, when the UE receives the DCI in a second slot of the first subframe, the UE may transmit the PUSCH scheduled by the DCI (or receive the PDSCH) in a second sub-BWP of the first or second BWP. In this case, the UE may transmit a PSUCH or receive a PDSCH based on the frequency hopping pattern. Through this, a phenomenon of resources being concentrated on the specific frequency or a specific sub-BWP (or a phenomenon of resources being concentrated and allocated) may be resolved.

When the frequency hopping pattern is configured, the UE may transmit and receive a signal as follows.
When DCI received in a first slot indicates that a PDSCH is transmitted in a second slot, the UE may determine a BWP and/or sub-BWP for a second slot according to a configured frequency hopping pattern, and determine a PDSCH resource in the determined sub-BWP of the determined BWP to receive the PDSCH. Here, the first slot and the second slot may be the same or different.
When the DCI received in the first slot indicates transmission of a PUSCH in the second slot, the UE may determine a BWP and/or sub-BWP for the second slot according to the configured frequency hopping pattern, and transmit the PUSCH based on the PUSCH resources allocated in the determined sub-BWP of the determined BWP. Here, the first slot and the second slot may be the same or different.
When a specific semi-persistent scheduling (SPS) is activated, the UE may determine a BWP and/or sub-BWP for a slot to which the corresponding SPS PDSCH is allocated according to a configured frequency hopping pattern, and receive the SPS PDSCH in an SPS PDSCH resource allocated in the determined sub-BWP of the determined BWP.
When a specific CG is activated, the UE may determine a BWP and/or sub-BWP for a slot to which a corresponding CG PUSCH is allocated according to a configured frequency hopping pattern, and transmit the CG PUSCH based on the CG PUSCH resources allocated to the determined sub-BWP of the determined BWP.

### R-SIB1 Reception of Rel.18 R-UE

The Rel.18 R-UE receives the Rel.18 PDSCH transmitting system information according to the methods 1, 2, and 3. In this case, the DCI of methods 1, 2, and 3 is DCI of which CRC is scrambled with SI-RNTI.

When Rel.18 PDSCH transmits R-SIB1 for Rel.18 R-UE, the DCI may schedule Rel.18 PDSCH for R-SIB1 as follows.
(1) Opt 1: One DCI on CORESET shared by pre-Rel.18 UE and Rel.18 UE schedules pre-Rel.18 SIB1 as well as Rel.18 R-SIB1 in FDM within an initial DL BWP of 20 MHz.
(2) Opt 2: One DCI on the CORESET shared by pre-Rel.18 UE and Rel.18 UE schedules pre-Rel.18 SIB1 within the initial DL BWP of 20 MHz as well as Rel.18 R-SIB1 outside the initial DL BWP of 20 MHz via FDM.
(3) Opt 3: One DCI on CORESET shared by pre-Rel.18 UE and Rel.18 UE schedules pre-Rel.18 SIB1 as well as Rel.18 R-SIB1 in FDM within an initial DL BWP of 20 MHz. In Opt3, Rel.18 PDSCH transferring Rel.18 R-SIB1 is scheduled within (sub)BWP of 5 MHz or BW position, and in contrast, a legacy PDSCH transferring pre-Rel.18 SIB1 is scheduled within an initial BWP of 5 MHz or an initial BWP of 20 MHz.

The BS may indicate via the DCI or MIB whether the DCI schedules both Rel.18 R-SIB1 and pre-Rel.18 SIB1, such as the Opt.

When a Rel.18 R-UE receives an existing SIB1 or a DCI scheduling the existing SIB1, the Rel.18 R-UE receives a separate cellBarred parameter for the Rel.18 R-UE from the existing SIB1 or from the DCI scheduling the existing SIB1. Based on the received cellBarred parameter, the Rel.18 R-UE determines whether the UE is capable of accessing a cell or whether the cell needs to be barred.

When the Rel.18 R-UE does not receive the existing SIB1 and receives anew R-SIB1 or a DCI scheduling an R-SIB1, the UE selects a sub-BWP for the R-SIB1 and receives a separate cellBarred parameter for the Rel.18 R-UE from the DCI of the selected sub-BWP or the R-SIB1. Based on the received cellBarred parameter, the Rel.18 R-UE determines whether the UE is capable of accessing a cell or whether the cell needs to be barred.

When on-demand SI is configured, the BS may configure dedicated RACH resources for on-demand SI requests. Alternatively, a dedicated RACH resource may be configured for UE identification during initial access. For the on-demand SI request or the UE identification during initial access, the BS may separately allocate RACH resources for Rel. 17 R-UEs, RACH resources for Rel. 18 R-UEs, and RACH resources for a normal UE. The BS may separately allocate a RACH resource for an option BW1 UE, a RACH resource for an option BW2 UE, and a RACH resource for an option BW3 UE for an Rel.18 R-UE. These different RACH resources may be separately allocated through the existing SIB1 and R-SIB1. In this case, the Rel.18 R-UE selects a PRACH resource that matches a UE type thereof and transmits MSG1 or MSGA. It may be possible to indicate an Rel.18 R-UE through the (sub-)header of the MAC PDU of MSG3 PUSCH or MSGA PUSCH, or to indicate an Option BW1 or BW2 or BW3 depending on a UE type.

### Paging Reception of Rel.18 R-UE

The Rel.18 R-UE receives the Rel.18 PDSCH transmitting a paging message according to the methods 1, 2, and 3. In this case, the DCI of methods 1, 2, and 3 is DCI of which CRC is scrambled with P-RNTI.

In the methods 1, 2, and 3, instead of the DCI, the DCI for paging early indication (PEI) may indicate a (sub-)BWP or BW location for the R-UE for Rel.18 paging PDSCH reception. Alternatively, in the methods 1, 2, and 3, instead of the DCI, the DCI for PEI may provide frequency domain resource allocation (FDRA) and/or time domain resource allocation (TDRA) information for Rel.18 paging PDSCH reception.

When the tracking reference signal (TRS) for paging is configured for Rel.18 R-UE, the Rel.18 TRS may be configured as follows.
(1) Opt 1: The TRS for paging of Rel.18 R-UE is configured only within the initial BWP or sub-BWP or BW location of 5 MHz for Rel.18 R-UE.

When a TRS for a Rel.18 R-UE performs frequency hopping, the TRS performs frequency hopping only within the initial BWP or sub-BWP or BW location of 5 MHz for the Rel.18 R-UE.
(2) Opt 2: The TRS for paging of Rel.18 R-UE is also configured outside the initial BWP or sub-BWP or BW location of 5 MHz for Rel.18 R-UE. In this case, the TRS is configured within the initial BWP for Rel.17 R-UE at 20 MHz.

The Rel.18 R-UE (especially UE with option BW1 or 2) receive TRS through RF re-tuning.

FIG. 10 is a diagram for explaining a method of transmitting and receiving a signal based on received DCI by a UE.

Referring to FIG. 10, the UE may receive downlink control information (DCI) from a BS through a physical downlink control channel (PDCCH). The DCI may include frequency domain resource allocation (FDRA) and/or time domain resource allocation information (TDRA) for reception of a PDSCH, or may include frequency domain resource allocation and/or time domain resource allocation information for transmission of a PUSCH.

Then, the UE may determine frequency resources for transmitting and receiving a signal based on an FDRA field included in the DCI (S103). In detail, the UE may be an R-UE capable of transmitting and receiving a signal only in a bandwidth of a specific bandwidth size. In this case, the UE may expect that frequency resources for transmitting and receiving the signal are allocated only within the bandwidth of the specific band size through the FDRA field included in the DCI. However, frequency resources that exceed the bandwidth of the specific band size may be allocated through the FDRA field included in the DCI, and in this case, as described in the “FDRA-based Sub-BWP Determination Method of DCI” section, frequency resources that exceed the bandwidth of the specific band size may be disregarded or reallocated.

The UE may not be indicated/configured with a Sub-BWP having a bandwidth size lower than or equal to the specific bandwidth size for the UL BWP related to the BS, or may not be indicated/configured with a Sub-BWP having a bandwidth size lower than or equal to the specific bandwidth size for the DL BWP. Even in this case, the UE (i.e., the R-UE of which transmission and reception of a signal is restricted to be performed within a bandwidth less than or equal to the specific bandwidth size) may perform transmission and reception of the signal by specifying the restricted frequency resources within the specific bandwidth size even if a plurality of frequency resources for a bandwidth larger than the specific bandwidth size are allocated through the FDRA field included in the DCI as described above (or, in the method described below).

In detail, when the FDRA field allocates a plurality of frequency resources for a second bandwidth exceeding a first bandwidth of the specific band size, the UE may transmit and receive the signal on frequency resources remaining except for at least one frequency resource from among the plurality of frequency resources. That is, the UE may not use the at least one frequency resource for transmission and reception of the signal even if the at least one frequency resource is allocated by the FDRA field. Here, the at least one frequency resource may be a frequency resource allocated outside the first bandwidth. For example, the UE may determine one or more frequency resources that are not located within the specific band size (i.e., in ascending order of frequency resource indices) based on (or from) the first frequency resource having the lowest index (e.g., the lowest RE index and/or RB index) from among the plurality of frequency resources as the at least one frequency resource. For example, the UE may determine one or more frequency resources that are not located within the specific band size (i.e., in descending order of frequency resource indices) based on (or from) the second frequency resource having the highest index (e.g., the highest RE index and/or RB index) from among the plurality of frequency resources as the at least one frequency resource. In this case, the UE may disregard the at least one frequency resource among the plurality of frequency resources allocated by the FDRA field and perform transmission and reception of the signal by using only the remaining frequency resources (i.e., frequency resources located within the specific bandwidth size from the frequency resource having the highest or lowest index from among the plurality of frequency resources).

Alternatively, the UE may exclude/disregard at least one frequency resource from among the plurality of frequency resources, and reallocate frequency resource(s) within the specific band size as many as the number of the at least one frequency resource(s). For example, when there are unallocated frequency resources from among the frequency resources within the specific bandwidth size that are not allocated by the FDRA field, the UE may reallocate as many unallocated frequency resources as the number of the at least one resource excluded/disregarded as frequency resources for transmitting and receiving the signal. The reallocation of the frequency resources may be performed in ascending or descending order based on the unallocated frequency resource having the highest or lowest index from among the indices of the unallocated frequency resources. In this case, the UE may transmit and receive the signal in the remaining frequency resources and the reallocated frequency resources.

Then, the UE may transmit or receive a signal scheduled by the DCI (S105). Here, transmission or reception of a signal may be determined depending on whether the DCI allocates a plurality of frequency resources to a certain signal. For example, the UE may receive the PDSCH by receiving the signal based on the resource allocation information when the DCI includes resource allocation information (FDRA or TDRA) for the PDSCH, and may transmit the PUSCH/PUCCH (i.e., UL signal) by transmitting the signal based on the resource allocation information when the DCI includes resource allocation information (FDRA or TDRA) for the PUSCH and/or PUCCH.

For example, the DCI may allocate the plurality of frequency resources to the UL signal, and a bandwidth to which the plurality of frequency resources are allocated may be greater than the first bandwidth. In this case, the UE may disregard at least one frequency resource from among the plurality of frequency resources and transmit the UL by using only the remaining frequency resources. Alternatively, the UE may disregard/exclude at least one frequency resource from among the plurality of frequency resources, and reallocate unallocated frequency resources within the first bandwidth equal to the number of the at least one frequency resource as frequency resources for transmission of the UL signal. In this case, the UE may transmit the UL signal in the remaining frequency resources and the reallocated frequency resources. Alternatively, the UE may reallocate unallocated frequency resources within the first bandwidth as frequency resources for transmission of the UL signal only when it is determined that the size of the remaining frequency resources, excluding at least one frequency resource from among the plurality of frequency resources allocated by the DCI, is not capable of accommodating the (data) size of the UL signal to be transmitted. In other words, the UE may not perform reallocation of unallocated frequency resources within the first bandwidth as frequency resources for transmission of the UL signal when the size of the remaining frequency resources, excluding at least one frequency resource from among the plurality of frequency resources allocated by the DCI, is capable of accommodating the (data) size of the UL signal to be transmitted.

Alternatively, the DCI may be received within a bandwidth part (BWP) supported for reception of the PDCCH. The BWP may be 20 Mhz. The BWP may be configured with a plurality of sub-BWPs having a bandwidth size less than or equal to the specific bandwidth size. In this case, the first bandwidth may correspond to one sub-BWP indicated/configured by the BS/cell from among a plurality of sub-BWPs.

As described above, the specific band size may be 5 MHz, which is a limited band size for an R18 R-UE type.

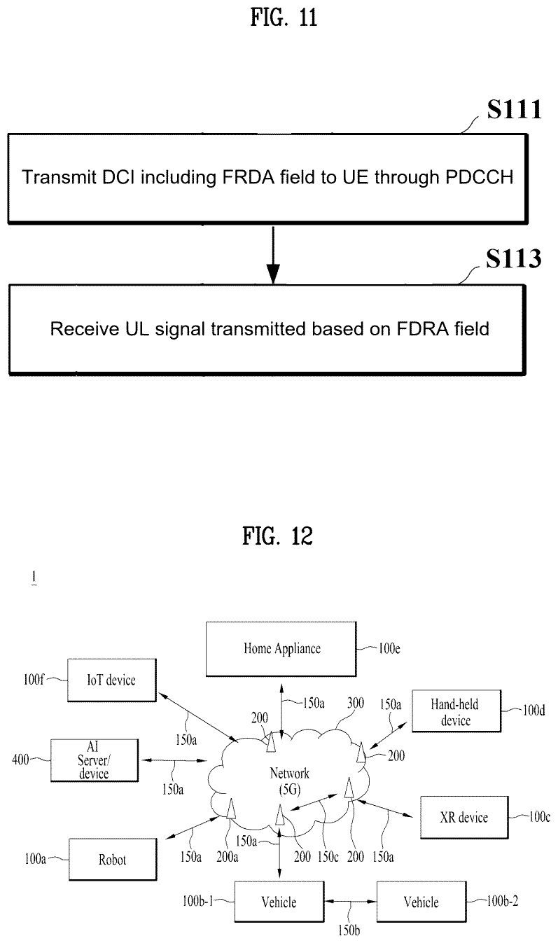

FIG. 11 is a diagram for explaining a method of receiving a UL signal by a BS from a UE.

Referring to FIG. 11, the BS may transmit downlink control information (DCI) to a UE through a physical downlink control channel (PDCCH). The DCI may include frequency domain resource allocation (FDRA) and/or time domain resource allocation information (TDRA) for transmission of the PUSCH.

Then, the BS may receive a UL signal transmitted based on the FDRA field (S113). Here, the UE may be an R-UE capable of transmitting and receiving a signal only in a bandwidth of a specific bandwidth size. In this case, when the BS allocates a plurality of frequency resources for a bandwidth exceeding a specific bandwidth size to the R-UE as the DCI, the BS may expect/determine that the UL signal is received in the remaining frequency resources excluding at least one frequency resource from among the plurality of frequency resources.

The at least one frequency resource may be a frequency resource allocated outside the first bandwidth, which is a bandwidth of the specific band size as described above. For example, the BS may determine one or more frequency resources that are not located within the specific band size (i.e., in ascending order of frequency resource indices) based on (or from) the first frequency resource having the lowest index (e.g., the lowest RE index and/or RB index) from among the plurality of frequency resources as the at least one frequency resource. Alternatively, the BS may determine one or more frequency resources that are not located within the specific band size (i.e., in descending order of frequency resource indices) based on (or from) the second frequency resource having the highest index (e.g., the highest RE index and/or RB index) from among the plurality of frequency resources as the at least one frequency resource. In this case, the BS may expect that the UL is not received in the at least one frequency resource from among the plurality of frequency resources allocated by the FDRA field and that the UL signal is received only in the remaining frequency resources (i.e., frequency resources located within the specific bandwidth size from the frequency resource of the highest or lowest index from among the plurality of frequency resources).

Alternatively, the BS may predict/expect that the UL is received in frequency resource(s) not allocated by the DCI within the specific bandwidth size as many as the number of the at least one frequency resource from among the plurality of frequency resources. In this case, the BS may receive the UL signal in the remaining frequency resources and in the frequency resource(s) not allocated by the DCI within the specific bandwidth size.

As such, even if a plurality of frequency resources for a bandwidth exceeding 5 MHz are allocated to the R18 RedCap UE by DCI, the UE may transmit the UL signal or receive the DL signal by using only the frequency resources within a bandwidth of 5 MHz from among the plurality of frequency resources. The UE may clearly determine/select frequency resources within the bandwidth of 5 MHz from among the frequency resources indicated by the DCI even if there is no configuration/indication for a bandwidth of 5 MHz within the BWP. The UE may only use frequency resources within the bandwidth of 5 MHz from among the frequency resources indicated by the DCI, and thus transmission of a UL signal and reception of a DL signal within the bandwidth of 5 MHz supported by the UE may be effectively ensured.

FIG. 12 illustrates a communication system 1 applied to the present disclosure.

Referring to FIG. 12, a communication system 1 includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 13 illustrates wireless devices applicable to the present disclosure.

Referring to FIG. 13, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 12.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

According to one example, the first wireless device 100 or UE may include a processor 102 and a memory 104 connected to the RF transceiver. The memory 104 may include at least one program capable of performing operations related to the embodiments described with reference to FIGS. 9 to 11.

In detail, the processor 102 may control the RF transceiver 106 to receive downlink control information (DCI) through a physical downlink control channel (PDCCH), and transmit or receive a signal based on a frequency domain resource allocation (FDRA) field included in the DCI, and based on the FDRA field allocating a plurality of frequency resources for a bandwidth exceeding a specific bandwidth size, the signal may be transmitted or received based on the remaining frequency resources excluding at least one frequency resource from among the plurality of frequency resources.

Alternatively, a processing device that controls a UE performing communication with a BS may include the processor 102 and the memory 104. In this case, the processing device may include at least one processor, and at least one memory connected to the at least one processor and storing instructions, and in this case, the instructions, when executed by the at least one processor, may cause the UE to receive downlink control information (DCI) through a physical downlink control channel (PDCCH), and transmit or receive a signal based on a frequency domain resource allocation (FDRA) field included in the DCI, and based on the FDRA field allocating a plurality of frequency resources for a bandwidth exceeding a specific bandwidth size, the signal may be transmitted or received based on the remaining frequency resources excluding at least one frequency resource from among the plurality of frequency resources.

Alternatively, a non-transitory computer-readable storage medium having recorded thereon instructions for performing the proposed methods described with reference to FIGS. 8 to 11 may be configured.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

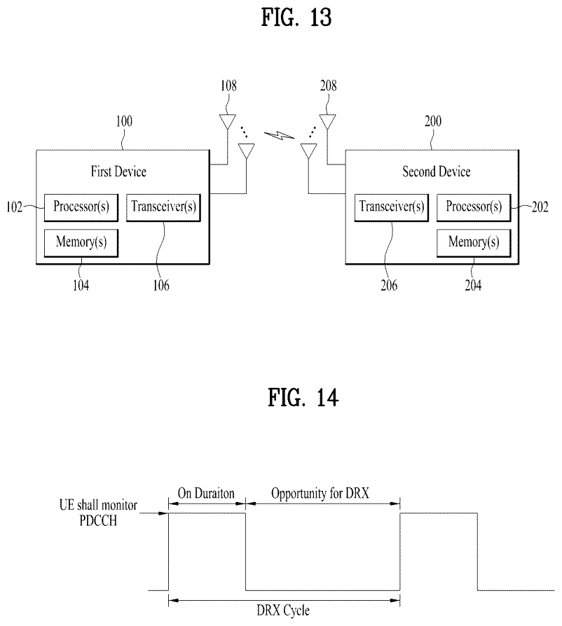

FIG. 14 is a diagram for explaining a DRX (Discontinuous Reception) operation of a UE according to one embodiment.

The UE can perform DRX operation while performing the procedures and/or methods described/suggested above. The UE with DRX configured can reduce power consumption by discontinuously receiving DL signals. DRX can be performed in the RRC (Radio Resource Control) IDLE state, the RRC_INACTIVE state, and the RRC_CONNECTED state. In the RRC_IDLE state and the RRC_INACTIVE state, DRX is used to discontinuously receive paging signals. Hereinafter, DRX performed in the RRC_CONNECTED state (RRC_CONNECTED DRX) will be described.

A DRX cycle consists of On Duration and Opportunity for DRX. The DRX cycle defines a time interval during which the On Duration is periodically repeated. The On Duration represents a time period during which the UE monitors to receive a PDCCH. When DRX is configured, the UE performs PDCCH monitoring during the On Duration. If a PDCCH is successfully detected during the PDCCH monitoring, the UE operates an inactivity timer and remains in an awake state. On the other hand, if no PDCCH is successfully detected during the PDCCH monitoring, the UE enters a sleep state after the On Duration ends. Therefore, when DRX is configured, PDCCH monitoring/reception may be performed discontinuously in the time domain when performing the procedures and/or methods described/proposed above. For example, when DRX is configured, a PDCCH reception opportunity (e.g., a slot having a PDCCH search space) in the present disclosure may be configured discontinuously according to the DRX configuration. On the other hand, when DRX is not configured, PDCCH monitoring/reception may be performed continuously in the time domain while performing the procedure and/or method described/proposed above. For example, when DRX is not configured, PDCCH reception opportunities (e.g., slots having PDCCH search spaces) in the present disclosure may be configured continuously. Meanwhile, PDCCH monitoring may be restricted in a time interval configured as a measurement gap, regardless of whether DRX is configured.

The above-described embodiments are combinations of elements and features of the present disclosure in specific forms. The elements or features may be considered selective unless mentioned otherwise. Each element or feature may be implemented without being combined with other elements or features. Further, the embodiments of the present disclosure may be configured by combining some elements and/or some features. Operation orders described in the embodiments of the present disclosure may be rearranged. Some constructions or features of any one embodiment may be included in another embodiment or may be replaced with corresponding constructions or features of another embodiment. It is obvious that claims that are not explicitly cited in the appended claims may be presented in combination as an embodiment of the present disclosure or included as a new claim by subsequent amendment after the application is filed.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure can be used in a UE, a base station, or other equipment of a wireless mobile communication system.

1. A method by a user equipment (UE) comprising:
receiving downlink control information (DCI) through a physical downlink control channel (PDCCH); and
transmitting or receiving a signal based on a frequency domain resource allocation (FDRA) field included in the DCI,
wherein, based on the FDRA field allocating a plurality of frequency resources for a bandwidth exceeding a specific bandwidth size, the signal is transmitted or received based on remaining frequency resources excluding at least one frequency resource from among the plurality of frequency resources.

2. The method of claim 1, wherein the at least one frequency resource is a frequency resource of which index is outside a bandwidth of the specific band size from a frequency resource having a lowest or highest index from among the plurality of frequency resources.

3. The method of claim 1, wherein the remaining frequency resources are frequency resources of which indices are included within a frequency band of the specific band size from a frequency resource having a lowest or highest index from among the plurality of frequency resources.

4. The method of claim 1, wherein the at least one frequency resource is disregarded in receiving or transmitting the signal even if the at least one frequency resource is allocated by the FDRA field.

5. The method of claim 1, wherein the UE reallocates frequency resources equal to a number of the at least one frequency resource excluded from among frequency resources not allocated by the FDRA field within a bandwidth of the specific band size as frequency resources for transmission of the signal.

6. The method of claim 5, wherein the signal is transmitted or received on the remaining frequency resources and the reallocated frequency resources.

7. The method of claim 1, wherein the signal is a physical downlink shared channel (PDSCH), a physical uplink shared channel (PUSCH), or a physical uplink control channel (PUCCH) scheduled by the DCI.

8. The method of claim 1, wherein the DCI is received within a bandwidth part (BWP) supported for reception of the PDCCH, and the BWP is configured with a plurality of sub-BWPs having a bandwidth size less than or equal to the specific bandwidth size.

9. The method of claim 8, wherein the bandwidth of the specific band size is one sub-BWP from among the plurality of sub-BWPs.

10. The method of claim 1, wherein the specific bandwidth size is 5 MHz.

11. (canceled)

12. A user equipment (UE) comprising:
a radio frequency (RF) transceiver; and
a processor connected to the RF transceiver,
wherein the processor controls the RF transceiver to receive downlink control information (DCI) through a physical downlink control channel (PDCCH), and transmit or receive a signal based on a frequency domain resource allocation (FDRA) field included in the DCI, and
wherein based on the FDRA field allocating a plurality of frequency resources for a bandwidth exceeding a specific bandwidth size, the signal is transmitted or received based on remaining frequency resources excluding at least one frequency resource from among the plurality of frequency resources.

13. (canceled)

14. A method by a base station (BS) comprising:
transmitting downlink control information (DCI) through a physical downlink control channel (PDCCH); and
receiving an uplink (UL) signal based on a frequency domain resource allocation (FDRA) field included in the DCI,
wherein, based on the FDRA field allocating a plurality of frequency resources for a bandwidth exceeding a specific bandwidth size, the signal is received based on remaining frequency resources excluding at least one frequency resource from among the plurality of frequency resources.

15. (canceled)
